(19) United States
(12) Patent Application Publication
(10) Pub. No.: US 2026/0131338 A1
(43) Pub. Date: May 14, 2026

(54) HANDS-FREE ELECTROSTATIC SPRAY DEVICE

(71) Applicant: Jennifer Cody Heaton, Hendersonville, NC (US)

(72) Inventor: Jennifer Cody Heaton, Hendersonville, NC (US)

(21) Appl. No.: 19/443,761

(22) Filed: Jan. 8, 2026

Related U.S. Application Data
(63) Continuation-in-part of application No. 18/753,071, filed on Jun. 25, 2024.
(60) Provisional application No. 63/525,694, filed on Jul. 9, 2023.

(51) Int. Cl. B05B 5/03; B05B 5/16

(52) U.S. Cl. CPC B05B 5/03; B05B 5/1691

(57) ABSTRACT

A spray device includes: a housing having a discharge opening; an electrode positioned near the discharge opening; an electrostatic generator coupled to the electrode; a compartment for receiving a pressurized canister of a chemical product having a valve movable between a closed position and an open position, the compartment configured to position the valve in fluid communication with the discharge opening; an actuator configured to move the valve between the open and closed positions; and an electronic controller programmed to: power the electrostatic generator; and operate the actuator to open the valve.

### BACKGROUND OF THE INVENTION

The present invention relates to aerosol dispensing devices, and more particularly to standalone devices which spray an aerosol into a room.

Through contaminated surface testing it has been found by the EPA that the advantages of an electromagnetic dispersion device far outweigh conventional disinfection methods. This is due to electrostatic sprayers applying a positive charge to liquid disinfectants as they pass through a spray nozzle. Currently there are only handheld/manually operated electrostatic applicators and they have been shown to have a very high transfer efficiency with the benefits being elimination of viruses, bacteria, and fungi.

There is, however, the concern of contact with the disinfectant/chemical agent that is being used within the device and the issues this could have on the operator's health as well as those that encounter the spray. For those who suffer with health issues such as but not limited to asthma, COPD, or skin allergies, these devices can be dangerous.

Accordingly, there is a need for a spraying device which avoids operator exposure.

### BRIEF SUMMARY OF THE INVENTION

This need is addressed by a standalone device configured to spray an agent which is ionized by an electrostatic generator. The device may include a time delay and a motion sensor.

According to one aspect of the technology described herein, a spray device includes: a housing having a discharge opening; an electrode positioned near the discharge opening; an electrostatic generator coupled to the electrode; a compartment for receiving a pressurized canister of a chemical product having a valve movable between a closed position and an open position; an actuator configured to move the valve between the open and closed positions; a start switch configured to select a time delay; and an electronic controller programmed to respond to operation of the start switch by counting down the selected time delay, and at expiration of the selected time delay to: power the electrostatic generator; and operate the actuator to open the valve.

According to another aspect of the technology described herein, a spray device includes: a housing having a discharge opening; a canister disposed in a compartment inside the housing, the canister configured to contain a pressurized chemical product, and having a valve movable between a closed position and an open position, the valve being positioned in flow communication with the discharge opening; an actuator configured to move the valve between the open and closed positions; an electrode positioned near the discharge opening; an electrostatic generator coupled to the electrode; a start switch configured to select a time delay; and an electronic controller programmed to respond to operation of the start switch by counting down the selected time delay, and at expiration of the selected time delay to power the electrostatic generator and to operate the actuator to open the valve.

### BRIEF DESCRIPTION OF THE DRAWINGS

The invention may be best understood by reference to the following description taken in conjunction with the accompanying drawing figures in which:

FIG. 1 is a front view of a spray device;

FIG. 2 is a rear view of the spray device of FIG. 1;

FIG. 3 is a top view of the spray device of FIG. 1;

FIG. 4 is a front view of the spray device of FIG. 1, with a door open, showing the interior of the spray device;

FIG. 5 is a cross-sectional view of the spray device of FIG. 1;

FIG. 6 is a partially-sectioned front view of an alternative spray device;

FIG. 7 is a partially-sectioned rear view of the spray device of FIG. 6;

FIG. 8 is a front view of a base portion of the spray device of FIG. 6;

FIG. 9 is a partially-sectioned bottom view of the spray device of FIG. 6;

FIG. 10 is a top view of the spray device of FIG. 6;

FIG. 11 is a sectional top-down view of the spray device of FIG. 6;

FIG. 12 is a schematic side view of a safety mechanism of the spray device of FIG. 6, in an extended position;

FIG. 13 is a top view of a safety latch shown in FIG. 12; and

FIG. 14 is a schematic side view of a safety mechanism of FIG. 12 in a retracted position.

### DETAILED DESCRIPTION OF THE INVENTION

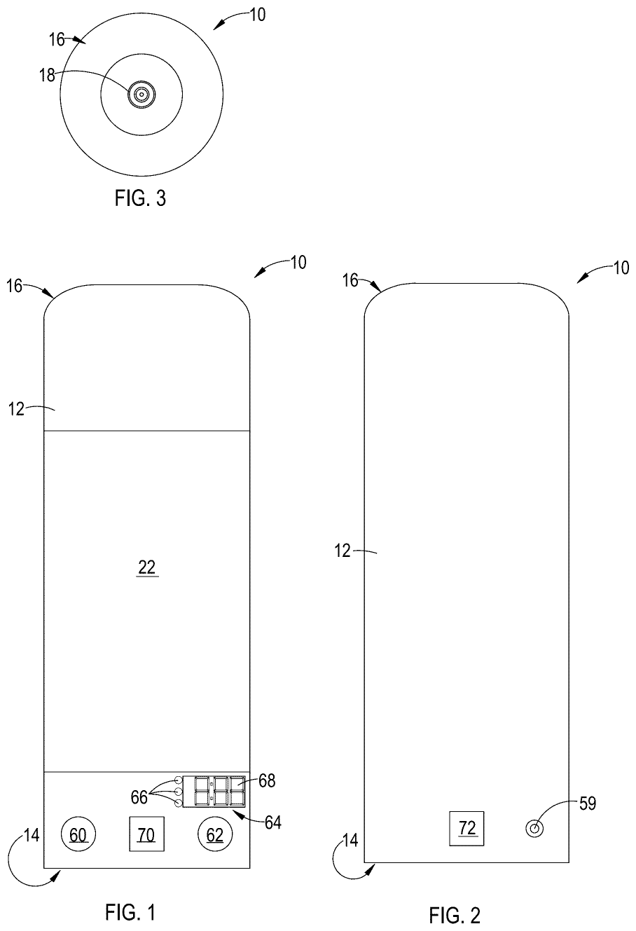

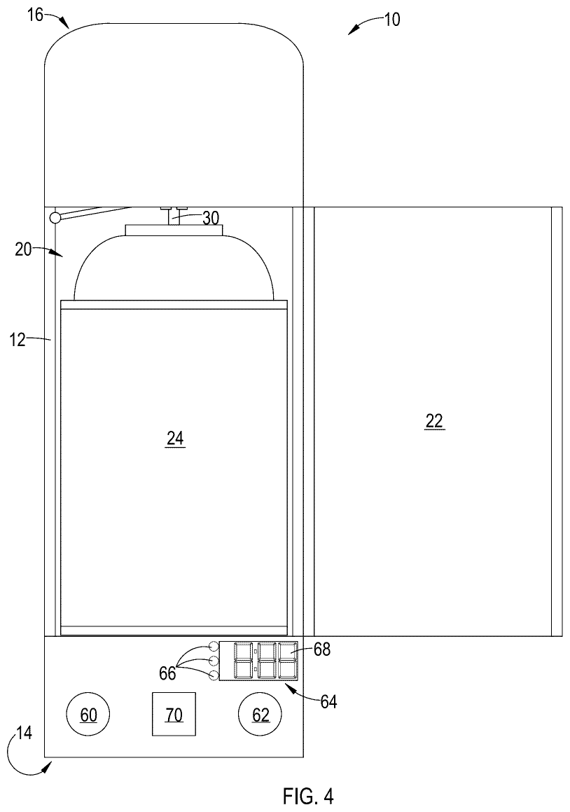

Referring to the drawings wherein identical reference numerals denote the same elements throughout the various views, FIGS. 1-3 illustrate an exemplary spray device 10. It includes a housing 12 which may be generally cylindrical, extending between a bottom end 14 and a top end 16. The top end 16 may have a dome shape and incorporates a discharge opening 18 which may be recessed from the top end 16. The housing 12 defines an interior compartment 20. This may be accessed via a door 22 which is movable between a closed position (FIG. 1) and an open position (FIG. 4). In the illustrated example, the door is mounted to the housing 12 via hinges, but alternatively it be mounted by other means or may be removable.

Referring to FIG. 4, a canister 24 is received in the interior compartment 20. The canister 24 is generally cylindrical, extending between a bottom end 26 and a top end 28. The canister 24 contains a chemical product, typically a liquid, and a propellant such as compressed air, inert gas, a hydrocarbon, or the like. The top end of the canister 24 includes a valve 30 which is generally cylindrical and arranged such that it is normally biased towards a closed position and opens, discharging the pressurized contents of the canister 24, in response to being depressed.

The interior compartment 20 may include means for positioning the canister 24 such as ribs, tabs, grooves, or the like (not shown). In the illustrated example, the bottom end 26 of the canister 24 rests on a flat shelf or bulkhead 32 which is formed as part of the housing 12.

In the illustrated example, the canister 24 is shown as being a removable item. This canister 24 may be provisioned as a factory-filled single use item or it may be refillable. Alternatively, the canister 24, whether single-use or refillable, may be incorporated as an integral component of the spray device 10. The canister 24 can be made of aluminum or other metal to facilitate recycling after use. In an alternative embodiment (not illustrated), an electrically-powered pump would be used to propel fluid through the nozzle described below, drawing the fluid from a reservoir similar to the canister 24.

The valve 30 is positioned so that it can spray the contents of the canister 24 through the discharge opening 18. Stated another way, the valve 30 is positioned in fluid communication with the discharge opening. In the illustrated example, the valve 30 is coupled to a nozzle 34 which is a part of the spray device 10. The nozzle 34 has an inlet end 36 which receives the valve 30 in a friction fit, and an outlet end 38 positioned in close proximity to the discharge opening 18.

Some means are provided for depressing the valve 30, causing pressurized canister contents to discharge through the nozzle 34 and out the discharge opening 18. In the illustrated example, a lever 40 is positioned in the interior compartment 20 with a first end 42 pivotally mounted to a wall of the housing 12 and a second end 44 coupled to an actuator 46 such as a solenoid. The lever 40 is arranged such that when the actuator 46 is energized, it moves the lever 40 which in turn forces the nozzle 34 downward, depressing the valve 30. Other types of actuators and mechanisms suitable for this purpose are known.

An ionizing electrode 48 surrounds or is positioned in close proximity to the outlet end 38 of the nozzle 34. This is electrically coupled to a electrostatic generator 50. The electrostatic generator 50 is operable to accept low voltage DC current and provide high voltage DC output. Suitable electrostatic charge voltages for disinfectants are in the range of 800 to 4000 volts, with a preferred range of 1500 to 3000 volts, with 2000 volts being an exemplary nominal value. These values are provided as non-binding examples only. Electrostatic generators of this type are commercially available.

The housing 12 further contains appropriate controls for operating the electrostatic generator 50 and the actuator 46. In the illustrated example, a printed circuit board 52 has an integrated circuit electronic controller 54 mounted thereto. The controller 54 is programmed or configured to respond to various controls and send commands to the electrostatic generator 50 and the actuator 46. Connections between the controller 54 and the other components of the spray device 10 may be made via wires as shown.

The spray device 10 includes an electrical power source of sufficient capacity to power the electrostatic generator 50, actuator 46, and controls and displays of the spray device 10.

The power source may comprise disposable or rechargeable batteries, or an external power source. In the illustrated example, the spray device 10 has a dual power supply comprising batteries 56 contained in a battery compartment 58 as well as a power input jack 59 (FIG. 2) for connection to a conventional DC power adapter (not shown) which converts AC mains electric power to DC current at an appropriate voltage. This setup allows the spray device 10 to operate with or without AC power being available. Example operating voltages are 5 to 24 VDC, one specific example being 8 VDC.

The spray device 10 includes appropriate controls for triggering the various functions.

A power switch 60 (FIG. 1) may be provided which is configured to connect or disconnect the power supply to the operating components of the spray device 10

A start switch 62 (FIG. 1) may be provided which is configured to initiate operation of the spray device and/or select a time delay. In one example, the spray device 10 is configured such that it starts operation after a predetermined time delay when the start switch 62 is actuated. In another example, repeated actuations of the start switch 62 cycle the selected time delay through various increments, and the spray device 10 starts operation after the selected delay from the last actuation of the start switch 62.

The spray device 10 may include one or more displays 64 operable to indicate the status of the spray device 10.

One possible display is a light 66 or group of lights which illuminate to show the selected time delay. In the illustrated example, one light 66 is provided for each time delay.

One possible display is a screen 68 such as an LCD or LED device that is configured to show numbers, letter, characters, or graphics. Optionally, the screen 68 may be touch sensitive to accept inputs.

The different types of displays may be used alone or together.

The spray device 10 may include one or more motion sensors. In the illustrated example a first motion sensor 70 is positioned on the front of the housing 12 (FIG. 1) and a second motion sensor 72 is positioned on the rear of the housing 12 (FIG. 2). One known type of motion sensor is a passive IR device. The number and position of the motion sensors may be configured so that collectively the motion sensors cover a 360° field of view around the spray device 10 As explained in more detail below, the controller 54 may be programmed to inhibit or interrupt operation of the spray device 10 when the motion sensor detects the presence of a human or animal.

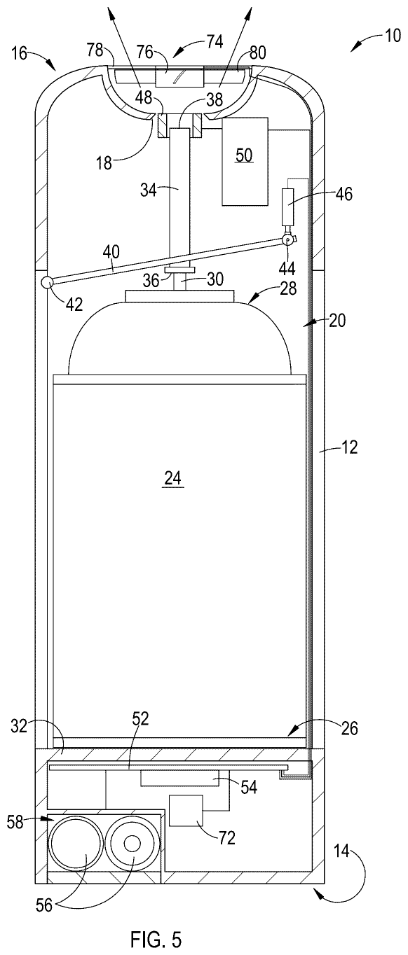

Optionally, the spray device 10 may include a powered fan 74 positioned downstream of the discharge opening 18. The example fan 74 (illustrated only in FIG. 5) includes a hub 76 which encloses an electric motor. The hub 76 is supported from the housing 12 by an array of struts 78 which form air flow channels between each other. An array of impeller vanes 80 extend from the hub 76. When rotated by the motor, the vanes 80 create an air flow as shown by the arrows. This airflow functions to propel the spray from the nozzle 34 and extend its range.

Operation of the spray device 10 is as follows.

Before use a pressurized canister 24 would be installed into the spray device 10, through the door 22, and the valve 30 engaged with the nozzle 34. Alternatively, if a permanently-installed canister 24 is used, it would be filled and pressurized. The spray device 10 would be placed in the area to be treated. The power switch 60 is then actuated to supply power to the operating components of the spray device 10.

When the user is ready, the start switch 62 would be actuated.

In one example, a single preset time delay would begin when the start switch 62 is actuated. In another example, a multiple timer system is used. The first switch operation may have a first timer (such as 10 seconds), and an optional second switch operation would provide a second longer time span (for example 20 seconds), and additional optional switch operations would provide additional time values (such as 30 seconds, 40 seconds, etc.). Optionally, the spray device 10 can be configured so that the time delay can correspond to an arbitrary time of day. In other words, the time delay could be several hours. Optionally, the spray device 10 can be configured so that it activates on a repeating schedule.

In any case, the display 64 (screen 68 and/or lights 66) may show the selected time delay. Optionally, the display 64 may indicate that the time delay is counting down.

Upon expiration of the time delay, the controller 54 will send power to the electrostatic generator 50 which will in turn energize the ionizing electrode 48. The controller will also energize the actuator 46, causing the valve 30 to open and discharge a spray of the product out the nozzle 34 and through the discharge opening 18. As it moves past the ionizing electrode 48, the product will receive electrostatic energy to ionize the particles in the aerosol. This will allow the particles to adhere to surfaces and into cracks often missed by handheld apparatuses. In a preferred example, the spray device 10 will be able to disinfect a room with an area in the range of 100 to 800 ft², with a preferred range of between 150 and 400 ft². If the optional fan 74 is used, the controller 54 would activate the fan 74 while the spray is being discharged.

The motion sensors 70, 72 may be configured to inhibit or interrupt operation of the spray device, protecting people and animals from exposure to the product.

For example, the controller 54 may be programmed to prevent the time delay from beginning to count down if either of the motion sensors 70 or 72 generates a signal that a human or animal is within its field of view.

In another example, the controller 54 may be programmed to permit the count down timer to run regardless of the status of the motion sensors 70, 72 but to prevent discharge of the spray if either of the motion sensors 70, 72 generates a signal that a human or animal is within its field of view.

In another example, the controller 54 may be programmed to cease the discharge of the spray if either of the motion sensors 70, 72 generates a signal that a human or animal is within its field of view.

The time delay and motion sensor will be effective to give the operator time to remove themselves from the unit's location, to close off multiple rooms. They will also provide protection should another enter the area of disbursement This will help to decrease direct contact with the agent used vastly decreasing respiratory issues or skin irritant issues from direct contact, as well as the ability to further condense the disinfecting or other agent used to a localized area if one should choose.

Once the spray device 10 has been used another canister 24 may be installed, or the canister 24 may be refilled, for use in other locations or at a later time.

The spray device 10 is suitable for spraying various products. One primary application of the spray device 10 is for spraying disinfecting chemicals. Disinfectant agents used can range from industrial products to household chemicals. The disinfectant may be of an Earth friendly (eco-friendly) type. Examples of chemicals that can be used for disinfecting using electrostatic assist include but are not limited to: ethanol, phenol, hydrogen peroxide, glutaraldehyde, formaldehyde, glycerin, dipropylene glycol, ammonium hydroxide, or benzalkonium chloride.

An alternative application of the spray device 10 is dispersion of chemicals to aid in the identification of fingerprints in a room. Examples of chemicals that can be used for fingerprinting include but are not limited to: such as cyanoacrylate, quaternary ammonium, sodium hypochlorite, silver nitrate, iodine, or ninhydrin.

Another alternative application of the spray device 10 is dispersion of chemicals to repel or kill insects. Examples of chemicals that can be used for repelling or killing insects include but are not limited to: organochlorines, organophosphates, organosulfurs, carbamates, formamidines, dinitrophenols, organotins, pyrethroids, nicotinoids, spinosyns, pyrazoles, pyridazinones, quinazolines, botanicals, antibiotics, fumigants, inorganics, biorationals, benzoylureas, pyrethrins, essential oils (e.g., citronella, clove, cedar, catnip, lavender, cinnamon, eucalyptus, or mint), witch hazel, or vodka.

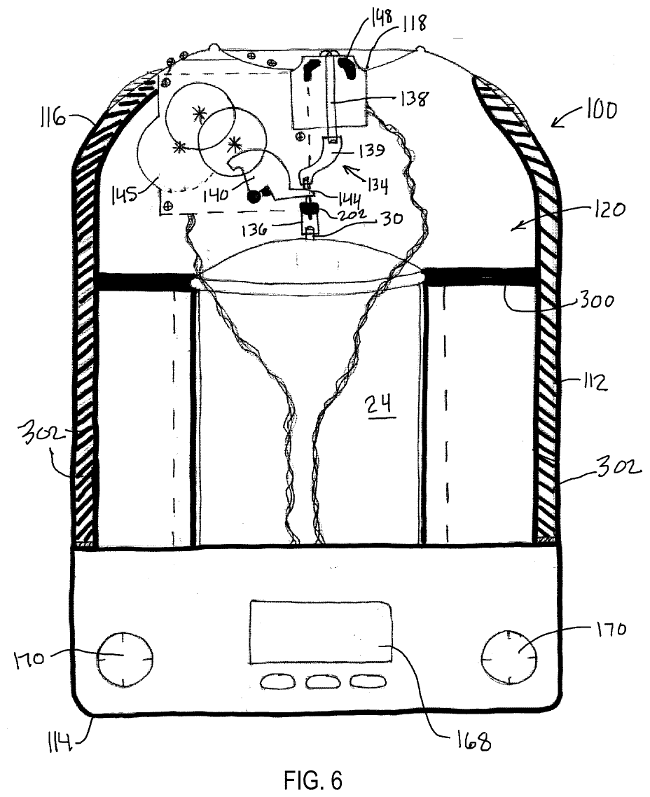

FIGS. 6-14 illustrate an alternative spray device 100. It is similar in overall functional concept to the spray device 10 described above. It includes a housing 112 which may be generally cylindrical, extending between a bottom end 114 and a top end 116. The top end 116 may have a dome shape and incorporates a discharge opening 118 which may be recessed from the top end 116. The housing 112 defines an interior compartment 120. This may be accessed via a door 122 which is movable between a closed position and an open position. The door 122 may be mounted to the housing 112 via hinges or other similar means, or may be removable.

Referring to FIG. 6, a canister 24 as described above is received in the interior compartment 120.

The interior compartment 120 may include means for positioning the canister 24 such as walls, ribs, tabs, grooves, or the like (not shown). In the illustrated example, best seen in FIG. 11, internal walls 300 of the housing 112 form a cradle 301 which receives and positions the canister 24.

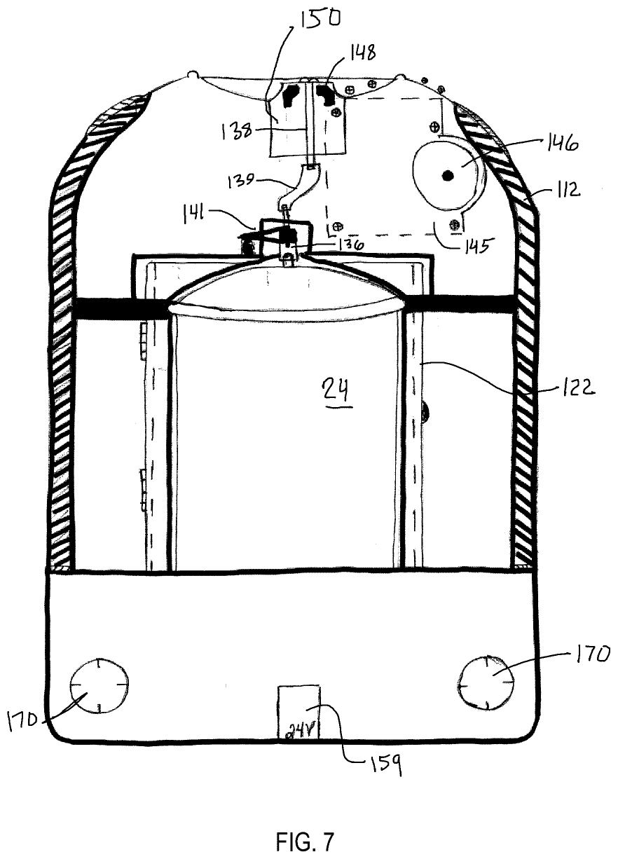

Referring back to FIG. 6, the valve 30 of the canister 24 is positioned so that it can spray the contents of the canister 24 through the discharge opening 118. Stated another way, the valve 30 is positioned in fluid communication with the discharge opening 118. In the illustrated example, the valve 30 is coupled to a nozzle assembly 134 which is a part of the spray device 100. The nozzle assembly 134 includes a safety connector 136 which receives the valve 30 in a friction fit, an outlet tube 138 positioned in close proximity to the discharge opening 118, and a flexible tube 139 interconnecting the safety connector 136 and the outlet tube 138. As best seen in FIG. 7, a spring 141 may be used to support the safety connector 136 in the housing 112.

Some means are provided for depressing the valve 30, causing pressurized canister contents to discharge through the nozzle assembly 134 and out the discharge opening 118. In the illustrated example (FIG. 6), a pivoting actuator arm 140 is positioned in the interior compartment 120 and is pivotally mounted in the housing 112 such that a finger 144 of the actuator arm 140 is positioned in close proximity to the safety connector 136. The actuator arm 140 is mechanically connected to an actuator 146 such as an electric motor. In the illustrated example, a gear train 145 connects the actuator 146 and the actuator arm 140. The actuator arm 140 is arranged such that when the actuator 146 is energized, it moves the actuator arm 140 which in turn forces the safety connector 136 downward, depressing the valve 30.

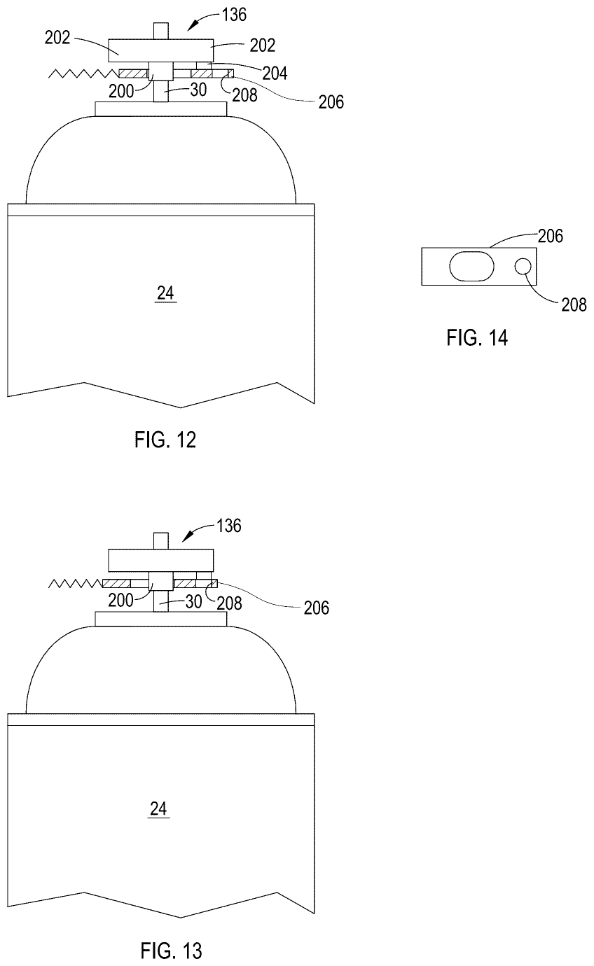

As noted above, the chemical agent that is being used within the device 100 may be hazardous to the operator. Accordingly, the device 100 may include a safety mechanism to permit the canister 24 to be coupled to the safety connector 136 while preventing accidental opening of the valve 30 and release of the canister's contents. Referring to FIG. 12, the safety connector 136 is generally T-shaped, with a cylindrical body 200 and lateral arms 202. When the device 100 is assembled and the canister 24 is installed, the actuator arm 140 rests above one of the lateral arms 202. When the actuator arm 140 is activated, it presses on the lateral arm 202 to open the valve 30.

One of the lateral arms 202 includes a blocking pin 204 that cooperates with a safety latch 206. The safety latch 206 is mounted in the housing 120, below the safety connector 136 and above the canister 24. It is movable between extended and retracted positions and is spring-loaded towards the extended position. The safety latch 206 has an opening 208 formed therein (FIG. 13). A trip arm 210 (FIG. 11) is attached to the door 122. When the door 122 is open, the trip arm 210 is clear of the safety latch 206, and the safety latch 206 moves to the extended position under spring pressure. The safety connector 136 and the safety latch 206 are configured such that when the safety latch 206 is in the extended position, a solid portion of the safety latch 206 is aligned with the blocking pin 204. In this condition, the safety connector 136 is accessible so that a user can manipulate it to make a connection with the canister nozzle 30. However, the safety latch 206 blocks downward motion of the safety connector 136 so that it cannot open the valve 30.

When the door 122 is closed, the trip arm 210 moves the safety latch 206 to the retracted position against the spring pressure, seen in FIG. 14. In the retracted position, the opening 208 is aligned with the blocking pin 204. In this position, full movement of the safety connector 136 is permitted, and it can move downwards when the actuator arm 140 is activated.

Stated another way, when the door 122 is open for loading or unloading a canister 24, the safety connector 136 is blocked from activating the valve 30. When the door 122 is in the closed position, the safety connector 136 is positioned so that it can operate the valve 30.

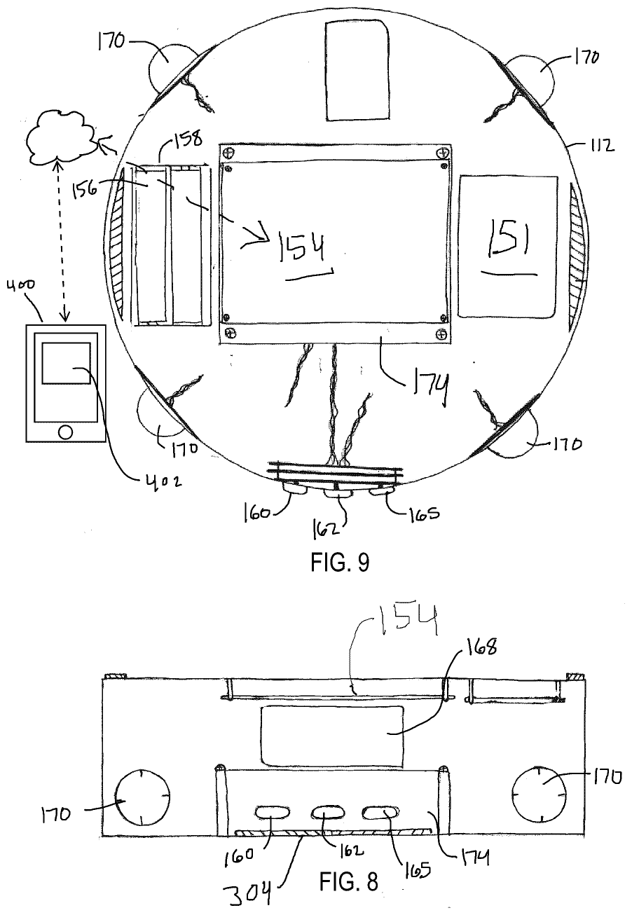

Referring back to FIG. 6, an ionizing electrode 148 surrounds or is positioned in close proximity to the outlet tube 138. This is electrically coupled to a electrostatic generator 150 (FIG. 9) of the type described above.

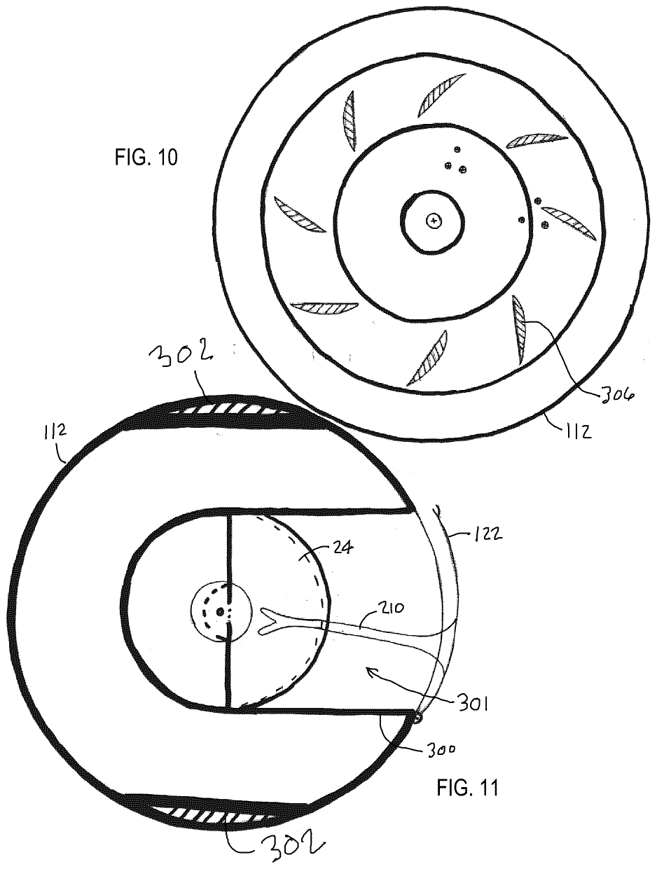

Optionally, the spray device 100 may include a powered fan 174 (FIG. 8) positioned in the housing 112, near the bottom end 114. The internal walls 300 of the housing define air channels 302 (FIG. 6) positioned outboard of the canister 24. When the fan 174 is operating, it draws air in through vents 304 near the bottom of the housing 112 and discharges the air through the air channels 302 and out the upper end 116 of the housing 112. This airflow functions to propel the spray from the outlet tube 138 and extend its range. The housing 112 may further incorporate integrated air vanes 306 (FIG. 10) that shape the air propelled by the fan 174 to create a swirling action to govern the dispersion of the media exiting the discharge opening 118 or to assist directing the media to dispense at a longer distance.

The housing 112 further contains appropriate controls for operating the electrostatic generator 150, the actuator 146, and optionally the fan 174. In the illustrated example (FIG. 9), an electronic controller 154 is provided. A non-limiting example of a suitable type of controller is a single-board computer such as a RASPBERRY PI device. The controller 154 is programmed or configured to respond to various controls and send commands to the electrostatic generator 150, the actuator 146, and optionally the fan 174. Connections between the controller 154 and the other components of the spray device 100 may be made via wires as shown. The controller 154 operates in conjunction with a supplemental control device 151 such as an Arduino unit to provide full control capabilities.

The spray device 100 includes an electrical power source of sufficient capacity to power the electrostatic generator 150, actuator 146, optional fan 174, and controls and displays of the spray device 100.

The power source may comprise disposable or rechargeable batteries, or an external power source. In the illustrated example, the spray device 10 has a dual power supply comprising batteries 156 contained in a battery compartment 158 (FIG. 9) as well as a power input jack 159 (FIG. 7) for connection to a conventional DC power adapter (not shown) which converts AC mains electric power to DC current at an appropriate voltage. This setup allows the spray device 10 to operate with or without AC power being available. Example operating voltages are 5 to 24 VDC, one specific example being 8 VDC.

The spray device 100 includes appropriate controls for triggering the various functions.

Referring to FIGS. 8 and 9, a power switch 160 may be provided which is configured to connect or disconnect the power supply to the operating components of the spray device 100.

A start switch 162 may be provided which is configured to initiate operation of the spray device and/or select a time delay. In one example, the spray device 100 is configured such that it starts operation after a predetermined time delay when the start switch 162 is actuated. In another example, repeated actuations of the start switch 162 cycles the selected time delay through various increments, and the spray device 10 starts operation after the selected delay from the last actuation of the start switch 162.

The spray device 10 may include one or more displays operable to indicate the status of the spray device 10. One possible display is a light or group of lights (not shown) which illuminate to show the selected time delay.

One possible display is a screen 168 such as an LCD or LED device that is configured to show numbers, letter, characters, or graphics. Optionally, the screen 168 may be touch sensitive to accept inputs.

The different types of displays may be used alone or together.

The spray device 100 may include one or more motion sensors. In the illustrated example four motion sensors 170 are positioned uniformly spaced around the housing 112. One known type of motion sensor is a passive IR device. The number and position of the motion sensors may be configured so that collectively the motion sensors cover a 360° field of view around the spray device 100. As explained in more detail below, the controller 154 may be programmed to inhibit or interrupt operation of the spray device 100 when the motion sensor detects the presence of a human or animal.

In addition to or as an alternative to the motion sensors, the spray device 100 may include one or more ranging sensors such as LIDAR or ultrasonic sensors (not shown), operably connected to the controller 154.

A sensor switch 165 may be provided which is configured to activate or deactivate the sensors 170.

Optionally, the controller 154 may be coupled to a microphone (not shown) and programmed to respond to voice commands to activate the various functions of the spray device 100.

Optionally, the spray device 100 may be configured for remote control, for example the controller 154 may be provided with or coupled to a network interface device and/or a transceiver e.g. a wireless data transfer protocol such as Wi-Fi or Bluetooth, to permit two-way network data communications. FIG. 9 illustrates a user computing device 400 such as a computer, tablet, or smart phone. Similarly, this is provided with means for two-way network data communications, for example over Wi-Fi or Bluetooth connections.

The user device 400 may be programmed with appropriate software (e.g. an “app” 402) which functions to receive data from the controller 154 and/or transmit commands to the controller 154.

The user device 400, using app 402, may be used to control the functions described above, such as powering the device 100 on or off, turning the fan 174 on or off, selecting a time delay, and controlling the operation of the motion sensors 170. The app 402 can be used further to schedule disbursement timing, alert or initiate reordering media, etc.

Optionally, artificial intelligence software such as a large language model (LLM), either local or accessed through the Internet, can be used to map or access a map of the building to track applications, apply media appropriate to the room type and function, and otherwise apply disinfectant based on learning.

The device described herein has advantages over prior art spraying devices. It will offer a cost-effective means for electrostatic disinfection of surfaces to cut down on germs, cross-contamination and the spread of viruses, bacteria, and fungi. It can be used in any building such as a home, office, nursing home, hospital, or medical office. It can be used when an individual in the environment has possibly contaminated the space to kill germs and keep sickness from spreading.

The foregoing has described an area spraying device. All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends any novel one, or any novel combination, of the features disclosed in this specification (including any accompanying claims, abstract and drawings), or to any novel one, or any novel combination, of the steps of any method or process so disclosed.

What is claimed is:

1. A spray device, comprising:
a housing having a discharge opening;
an electrode positioned near the discharge opening;
an electrostatic generator coupled to the electrode;
a compartment for receiving a pressurized canister of a chemical product having a valve movable between a closed position and an open position, the compartment configured to position the valve in fluid communication with the discharge opening;
an actuator configured to move the valve between the open and closed positions; and
an electronic controller programmed to:
power the electrostatic generator; and
operate the actuator to open the valve.

2. The spray device of claim 1, further comprising a switch mounted to the housing, wherein the electronic controller is programmed to respond in response to operation of the start switch.

3. The spray device of claim 1, further comprising a user computing device in data communication with the electronic controller, wherein the electronic controller is programmed to operate the actuator in response to a command from the user computing device.

4. The spray device of claim 3, wherein the data communication uses a wireless data transfer protocol.

5. The spray device of claim 1, further comprising at least one motion sensor operably connected to the controller.

6. The spray device of claim 5, wherein the number and position of the motion sensors are configured so that collectively the motion sensors cover a 360° field of view around the spray device.

7. The spray device of claim 5, wherein the controller is programmed to respond to a signal from the at least one motion sensor by operating the actuator to close the valve.

8. The spray device of claim 1, further comprising a display operable to indicate a status of the device.

9. The spray device of claim 1, further comprising a powered fan positioned in the housing and configured to propel an air flow past the discharge opening.

10. The spray device of claim 9, further comprising a plurality of integrated airplanes position to swirl the airflow generated by the powered fan.

11. The spray device of claim 1, further comprising a nozzle having an inlet end which receives the valve in a friction fit, and an outlet end positioned in close proximity to the discharge opening.

12. The spray device of claim 1, further comprising a nozzle assembly including:
an outlet tube positioned in close proximity to the discharge opening;
a safety connector configured to receive the valve in a friction fit; and
a flexible tube interconnecting the safety connector and the outlet tube.

13. The spray device of claim 12, wherein the safety connector includes a cylindrical hub with a pair of lateral arms extending outward therefrom.

14. The spray device of claim 1, further comprising:
a pivoting actuator arm positioned in the housing in close proximity to the nozzle; and
a geartrain mechanically connecting the pivoting actuator arm to the actuator.

15. The spray device of claim 1, further comprising:
a safety connector configured to receive the valve in a friction fit; and
a safety latch mounted in the housing adjacent to the safety connector, wherein the safety latch is movable between an extended position in which it blocks movement of the safety connector, and a retracted position in which it prevents movement of the safety connector.

16. The spray device of claim 15, wherein the safety latch is spring-loaded towards the extended position.

17. The spray device of claim 15, further comprising:
a door coupled to the housing and movable between an open position and a closed position; and
a trip arm coupled to the door, the trip arm configured such that when the door is closed it moves the safety latch to the retracted position.

18. The spray device of claim 1, further comprising internal walls of the housing the define a cradle configured to receive and position the canister.

19. The spray device of claim 1, wherein the electronic controller is programmed to respond to a command by counting down they selected time delay prior to powering the electrostatic generator and operating the actuator.
